(19) United States
(12) Patent Application Publication
(10) Pub. No.: US 2016/0209040 A1
(43) Pub. Date: Jul. 21, 2016

(54) GAS TURBINE COMBUSTOR AND GAS TURBINE ENGINE EQUIPPED WITH SAME

(71) Applicant: MITSUBISHI HITACHI POWER SYSTEMS, LTD., Yokohama-shi (JP)

(72) Inventors: Issei TAMURA, Tokyo (JP); Keijiro SAITO, Tokyo (JP); Kei INOUE, Tokyo (JP); Shinji AKAMATSU, Tokyo (JP)

(21) Appl. No.: 14/913,595

(22) PCT Filed: Sep. 22, 2014
(86) PCT No.: PCT/JP2014/074995

§ 371 Date: Feb. 22, 2016

(30) Foreign Application Priority Data
Sep. 27, 2013 (JP) 2013-201573

(51) Int. Cl. F23R 3/28; F02C 3/14; F02C 7/228; F02C 3/04

(52) U.S. Cl. CPC F23R 3/286; F02C 3/04; F02C 3/14; F02C 7/228; F05D 2220/32; F05D 2240/35

(57) ABSTRACT

The liquid fuel-using gas turbine combustor prevents the generation of combustion oscillation. The gas turbine combustor is provided with a pilot burner disposed on the central position of the combustion casing, main burners disposed so as to surround the pilot burner. The main burners are configured such that a main nozzle is installed in the central portion of a cylindrical premixing nozzle, with a liquid fuel being injected from fuel injection holes (provided at the periphery of the main nozzle) toward the inner surface of an elongated nozzle connected to the downstream side of the premixing nozzle, and with the injection pattern of the fuel being set so as to differ among the multiple main burners. For example, different injection patterns can be provided by setting different liquid fuel injection angles (θ1, θ2) for the fuel injection holes on the multiple main burners.

### TECHNICAL FIELD

The present invention relates to a gas turbine combustor that prevents the generation of combustion oscillation and a gas turbine engine provided with the same.

### BACKGROUND ART

In recent years, there has been an increased interest in environmental conservation, as well as a demand for a reduction in emissions of nitrogen oxides (NOx) and the like. This also holds for the field of gas turbine engines, and research and development of various natures are progressing, particularly in that pertaining to combustors.

The combustors widely used in many gas turbine engines are a premix type combustor in which a pilot burner is centrally disposed in a combustion casing and a plurality of main burners are disposed so as to surround the periphery of the pilot burner. Gas turbine engines can be of the type that combusts gaseous fuel such as liquid natural gas (LNG), or the type that combusts liquid fuel such as kerosene and A-type heavy oils.

Whether gaseous fuel or liquid fuel is used as fuel, the combustor shares a configuration in which a fuel is injected into the flow of compressed air in the premixing nozzle of a main burner to create in advance a fuel-air mixture containing the compressed air and the fuel. The fuel-air mixture is then ignited by flames emitted from the pilot burner and combusts, the produced high temperature, high pressure combustion gas driving the turbines downstream of the combustor. By pre-mixing the compressed air and the fuel in such a manner, the proportion of the volume of air to the volume of fuel can be adjusted comparatively freely, and the proportion of air present in the combustion (percentage of excessive air) can be increased. As a result, the combustion temperature can be lowered, thus reducing the amount of NOx generated.

However, premix type gas turbine combustors have a tendency to generate combustion oscillation. When combustion oscillation occurs, the combustion becomes unstable due to the range of fluctuation in combustion pressure increasing, and low frequency cyclic vibration and noise caused by periodic fluctuations in the pressure of the combustor are generated.

Combustion oscillation occurs when the periodic fluctuations in pressure inside the combustor caused by combustion resonate with the hydrodynamic natural vibration frequency of the combustor. Specifically, conventional configurations comprise flames emitted from a plurality of main burners all having the same shape. As a result of this configuration, the heat release position of the injection flames emitted from each of the main burners tends to be concentrated at the same position in the axial direction of the combustor, the rise in temperature at this concentrated heat release region also causing a rapid rise in the pressure of the combustion gas. The resulting pressure waves travel through the combustor, creating a state in which resonance and thus combustion oscillation can easily occur.

Patent Documents 1 and 2 described gas turbine combustors configured to suppress such combustion oscillation.

Patent Document 1 describes a gas turbine combustor comprising swirlers provided on two or more premixing ducts having different swirl angles, so that the length (shape) of the flames emitted from the premixing ducts inside the combustion chamber differ from one another. As a result of this configuration, the heat release position of the injection flames concentrating in one position in the axial direction of the combustor is avoided, thus suppressing combustion oscillation.

Patent Document 2 describes a gas turbine combustor comprising elliptical elongated ducts connected to a downstream side of main nozzles (premixing nozzles), wherein the shape of the ducts differs. As a result of this configuration, the premixed air from all of the main nozzles is prevented from being ignited and combusted at the same position in the axis line direction of the combustor, heat release position of the injection flames is prevented from being concentrated at one position, and combustion oscillation is suppressed.

### CITATION LIST

### Patent Literature

Patent Document 1: Japanese Unexamined Patent Application Publication No. 2003-139326A
Patent Document 2: Japanese Unexamined Patent Application Publication No. 2001-254947A

### SUMMARY OF INVENTION

### Technical Problem

However, while the conventional gas turbine combustors described above in Patent Documents 1 and 2 have contributed to the field of gas turbine combustors that use fuel gas, they have minimal influence in the field of gas turbine combustors that use liquid fuel due to a difference in length (shape) of the flames being difficult to achieve without varying the concentration distribution of the fuel-air mixture (containing the compressed air and the liquid fuel) amongst the plurality of premixing nozzles.

Also, implementing configurations such as that of Patent Document 1, in which the swirl angle differs amongst the swirlers provided in the premixing duct, or that of Patent Document 2, in which the shape of the elliptical elongated ducts differs, means significant changes to the configuration of gas turbine combustors, which in turn may lead to, for example, great costs involved in refitting existing gas turbine combustors.

In addition, there is a possibility of a change in the shape pressure loss of the air causing an unbalance in the air distribution in the gas turbine combustors of Patent Documents 1 and 2, due to the shape of the air flow path differing amongst the main nozzles (main burners). As a result, the average flame speed increases at the main nozzles supplied with minimal air, and the amount of NOx produced by the combustor as a whole tends to increase.

The present invention was conceived in light of the issues described above, and an object of the present invention is to provide a gas turbine combustor and a gas turbine engine provided with the same having a simple and high cost-performance liquid-fuel-using configuration by which the amount of NOx produced can be reduced and combustion oscillation can be prevented from occurring.

### Solution to Problem

In order to solve the above-described problem, the present invention provides the following means.

Specifically, a gas turbine combustor according to a first aspect of the present invention comprises: a pilot burner centrally disposed in a combustion casing; and a plurality of main burners disposed so as to surround the periphery of the pilot burner; each of the main burners comprising a main nozzle centrally disposed in a cylindrical premixing nozzle, a liquid fuel being injected from fuel injection holes provided on a periphery of the main nozzle towards an inner surface of an elongated nozzle connected to a downstream side of the premixing nozzle; and an injection pattern of the liquid fuel injected from the fuel injection holes towards the inner surface of the elongated nozzle being set to differ amongst the plurality of main burners.

According to the gas turbine combustor, because of the injection pattern of the liquid fuel differing amongst the plurality of main burners, the concentration distribution of the fuel-air mixture (containing the compressed air and the liquid fuel) can be varied amongst the main burners, thus giving variance to the length and shape of the combustion flames emitted from the main burners. As a result, the heat release rate distribution and the point of maximum heat release of the plurality of combustion flames can be prevented from being concentrated at one position in the axial direction of the combustor, and combustion oscillation can be prevented.

Moreover, by keeping the shape of air flow paths the same amongst the plurality of main burners, shape pressure loss of the air does not change and unbalance in air distribution does not occur. Consequently, NOx generation caused by the increased average flame speed at the specific main burners that use minimal amounts of air is suppressed, and the amount of NOx generated by the combustor as a whole can be reduced.

As a configuration in which the injection pattern of the liquid fuel injected from the fuel injection holes differs amongst the plurality of main burners, the angle of injection of the liquid fuel from the fuel injection holes may differ amongst the plurality of main burners.

Similarly, as a configuration in which the injection patterns of the liquid fuel differ from one another, the position of the fuel injection holes on the main nozzle may differ amongst the main burners. The position of the fuel injection holes stated here may mean the position of the fuel injection holes on the main nozzle in the axial direction or circumferential direction, or the pattern in which the fuel injection holes are disposed.

Similarly, as a configuration in which the injection patterns of the liquid fuel differ from one another, the number of fuel injection holes on the main nozzle may differ amongst the main burners.

Similarly, as a configuration in which the injection patterns of the liquid fuel differ from one another, the diameter of the fuel injection holes on the main nozzle may differ amongst the main burners.

A simple, low-cost configuration in which the fuel injection holes on the main nozzle differ amongst the main burners as described above in terms of the angle of the fuel injection, the position of the fuel injection holes, the number of fuel injection holes, the diameter of the fuel injection holes, and the like, allows for the injection pattern of the liquid fuel to differ amongst the plurality of main burners, thus giving variance to the length and shape of the combustion flames emitted from the main burners. As a result, the heat release rate distribution (point of maximum heat release) of the plurality of combustion flames can be prevented from being concentrated at one position in the combustor, and combustion oscillation can be suppressed.

Also, according to any of the configurations described above, the injection patterns may differ due to a position of the main nozzle with respect to the premixing nozzle being variable in at least one direction of the group consisting of an axial direction and a circumferential direction.

According to the configuration described above, even in the case of the main nozzles themselves having no difference in terms of angle of fuel injection, position, number, diameter, and the like of the fuel injection holes, the position of the fuel injection holes can be varied in the axial and circumferential direction by varying the position of the main nozzle in at least one direction of the group consisting of the axial direction and the circumferential direction. Consequently, the injection pattern of the liquid fuel injected from the plurality of main burners can be set to a greater variety of configurations.

Next, a gas turbine engine according to a second aspect of the present invention comprises a compressor that compresses air; the gas turbine combustor, having any of the configurations described above, that combusts a fuel injected into the air compressed by the compressor; and a turbine driven by the expansion of a combustion gas exiting from the gas turbine combustor.

According to the configuration described above, the gas turbine engine that uses liquid fuel has a comparatively simple, low cost configuration in which fuel injection holes provided on the main nozzles are varied, or only the position of the main nozzles is varied in the axial direction and/or the circumferential direction. As a result of the configuration, the concentration distribution of the fuel-air mixture (containing the compressed air and the liquid fuel) is varied amongst the main burners, and the length (shape) of the flames emitted from the main burners is varied. Consequently, the heat release position (heat release rate distribution) of the plurality of injection flames can be prevented from being concentrated in one position in the axial direction of the combustor, and combustion oscillation can be suppressed.

### Advantageous Effects of Invention

As described above, according to the gas turbine combustor and the gas turbine engine provided with the same of the present invention, a gas turbine combustor that uses liquid fuel can prevent the generation of combustion oscillation with a simple, high cost-performance configuration.

### BRIEF DESCRIPTION OF DRAWINGS

FIG. 1 is a longitudinal cross-sectional view along the axial direction of a gas turbine combustor of a first embodiment of the present invention.

FIG. 2 is a longitudinal cross-sectional view along line II-II of FIG. 1 illustrating the gas turbine combustor.

FIG. 3 is a longitudinal cross-sectional view of a main burner and combustion flames and a heat distribution graph illustrating the effects of the first embodiment.

FIG. 4 is a longitudinal cross-sectional view of the main burner and combustion flames of a second embodiment of the present invention.

FIG. 5 is a front view of the main burners (main nozzles, fuel injection holes, and elongated nozzles) of a third embodiment of the present invention.

FIG. 6 is a front view of the main burners (main nozzles, fuel injection holes, and elongated nozzles) of a fourth embodiment of the present invention.

FIG. 7 is a longitudinal cross-sectional view of the main burner and the combustion flames of a fifth embodiment of the present invention.

### DESCRIPTION OF EMBODIMENTS

Hereinafter, embodiments of a gas turbine combustor according to the present invention are described with reference to the drawings.

### First Embodiment

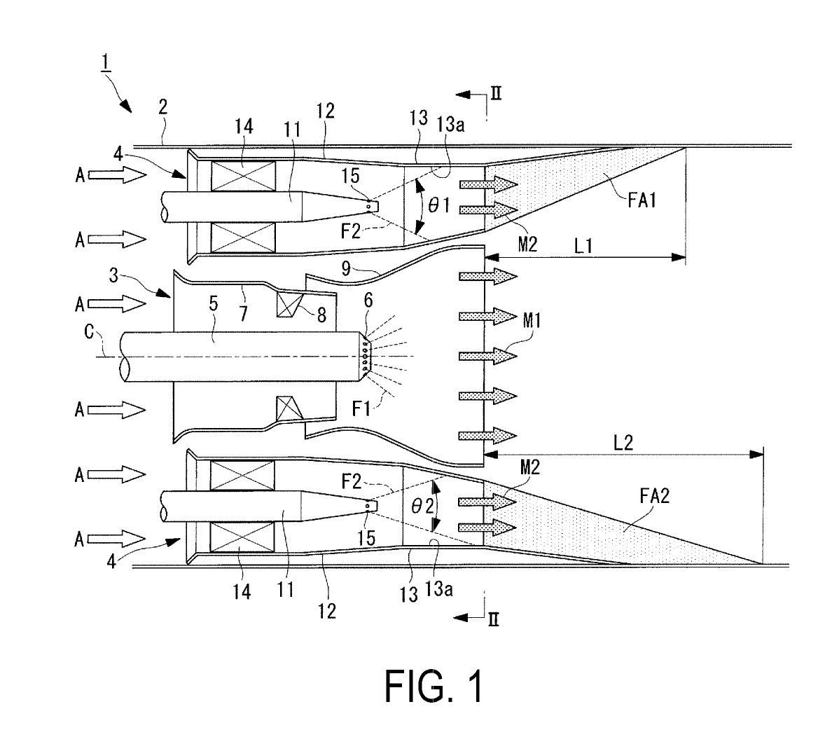

FIG. 1 is longitudinal cross-sectional view of a gas turbine combustor of a first embodiment of the present invention.

The gas turbine combustor 1 can be mounted on a gas turbine engine (not illustrated). Gas turbine engines, as is widely known, are provided with a compressor that compresses air, a gas turbine combustor that combusts a fuel injected into the air compressed by the compressor, and a turbine driven by the expansion of a combustion gas that exits from the gas turbine combustor. The energy of the combustion gas produced in the gas turbine combustor is utilized to rotationally drive the turbine at high speed, thereby producing shaft power to drive a generator or the like. The gas turbine combustor 1 of the present invention may be used as the above-described gas turbine combustor.

The gas turbine combustor 1 has a typical configuration of a premixing combustor, the gas turbine combustor 1 being provided with a combustion casing 2 that corresponds to the outer periphery of the gas turbine combustor 1, a pilot burner 3 disposed aligned with a central axis line C of the combustion casing 2, and a plurality (for example, 8) main burners 4 disposed at equal intervals so as to surround the periphery of the pilot burner 3. Note that the compressed air A compressed by the compressor (not illustrated) flows through the inside of the gas turbine combustor 1 (combustion casing 2) from the left side towards the right side with respect to FIG. 1.

The pilot burner 3 is provided with a shaft-shaped pilot nozzle 5 on a central axial portion of the pilot burner 3. The tip on the downstream side of the pilot nozzle 5 is provided with a plurality of fuel injection holes 6. In addition, a substantially funnel-shaped pilot nozzle casing 7 is attached so as to surround the periphery of the pilot nozzle 5 with a gap left therebetween. The diameter of the pilot nozzle casing 7 gradually decreases in the downstream direction of the flow of the compressed air A.

A plurality of wing-shaped pilot swirlers 8 are disposed on the inner surface of the pilot nozzle casing 7, extending towards the pilot nozzle casing 7 side. The pilot swirlers 8 have a pitch angle inclined in the same direction as one another. Consequently, the flow of the compressed air A flowing through the inside of the pilot nozzle casing 7 becomes a circulating flow (a swirling flow).

In addition, a pilot cone 9 is provided so as to surround the periphery of the pilot nozzle 5. The pilot cone 9 is substantially funnel-shaped with a diameter that increases in the downstream direction of the flow of the compressed air A. The downstream end portion of the pilot nozzle casing 7 is inserted to a small degree inside of an upstream end portion of the pilot cone 9 with a gap in the radial direction left therebetween.

A liquid fuel F1 is injected from the fuel injection holes 6 on the pilot nozzle 5 into the circulating flow (swirling flow) of the compressed air A flowing through the inside of the pilot nozzle casing 7. Because of the compressed air A being circulated, the mixing of the compressed air A with the liquid fuel F1 is accelerated. In such a manner, a fuel-air mixture M1 is produced by premixing the liquid fuel F1 with the compressed air A in the pilot burner 3.

The fuel-air mixture M1 is ignited by a pilot flame (not illustrated) upon being injected from the pilot cone 9 towards a combustion region (not illustrated), and diffusion combustion takes place inside the pilot cone 9 or downstream thereof. Note that the fuel-air mixture M1 injected from the pilot burner 3 and combustion flames thereof are prevented from being diffused in a centrifugal direction by the pilot cone 9. As a result, interference of the combustion flames of a fuel-air mixture M2 from the main burners 4 described below is prevented.

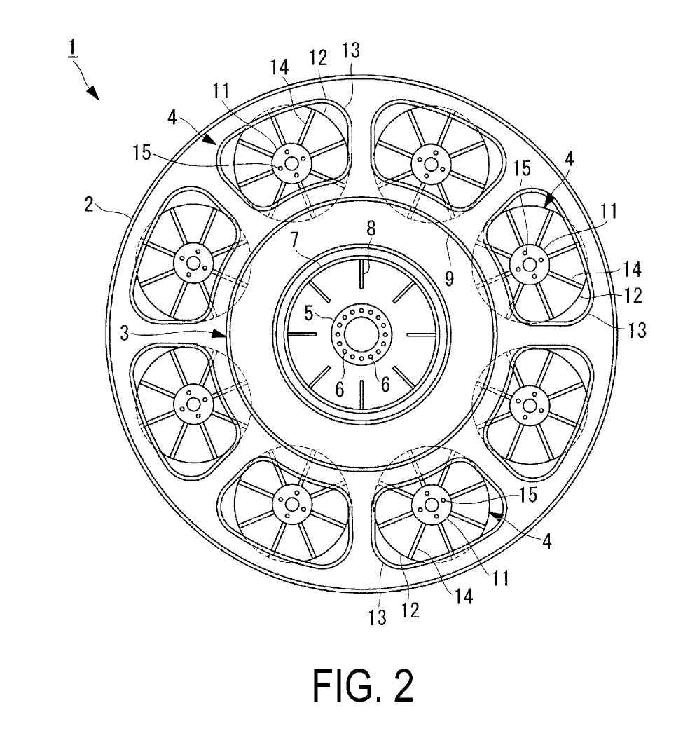

Moving now to the plurality of main burners 4, each of the main burners 4 are provided with a shaft-shaped main nozzle 11 on a central axial portion thereof. Each of the main nozzles 11 has a tapered conical shape with an end portion on the downstream side of the flow of the compressed air A that becomes narrower towards the tip. Also, a premixing nozzle 12 is provided so as to surround the periphery of the main nozzle 11. The premixing nozzle 12 has a substantially cylindrical shape with an expanding bell mouth shape at an inlet on the upstream side of the premixing nozzle 12. An outlet on the downstream side of the premixing nozzle 12 is connected to an elongated nozzle 13. An end portion of the elongated nozzle 13 on the premixing nozzle 12 side is circular. However, the opening of the end portion on the outlet side of the elongated nozzle 13 is substantially fan-shaped, with the shape following the inner surface of the combustion casing 2 and the outer surface of the pilot cone 9, as illustrated in FIG. 2.

A plurality of wing-shaped main swirlers 14 (see FIG. 1) radially extending from the outer surface of the main nozzle 11 are fixed to the inner surface of the premixing nozzle 12. The main nozzle 11 is fixed in the central portion of the premixing nozzle 12 by the main swirlers 14. Each of the main swirlers 14 has a pitch angle inclined in the same direction as one another. Consequently, circulating flow (swirling flow) sharing the same rotational direction occurs in the flow of the compressed air A flowing through the inside of each of the premixing nozzles 12.

The main nozzle 11 is provided with a plurality of fuel injection holes 15 on the circular conical outer surface approximate to the tip of the main nozzle 11. A liquid fuel F2 is injected from the fuel injection holes 15. The liquid fuel F2 is injected in an inclined manner towards an inner surface 13a of the elongated nozzle 13. As a result of the liquid fuel F2 hitting the inner surface 13a, the liquid fuel F2 is atomized and mixed with the compressed air A. The mixing of the compressed air A and the liquid fuel F2 is accelerated due to the compressed air A being circulated inside the premixing nozzle 12.

In such a manner, the fuel-air mixture M2 is produced by premixing the liquid fuel F2 with the compressed air A in the main burners 4. The fuel-air mixture M2 is then injected towards the combustion region (not illustrated) from the elongated nozzle 13, where the fuel-air mixture M2 is ignited by the combustion flames of the fuel-air mixture M1 injected from the pilot burner 3. As a result, combustion flames FA1, FA2 are formed. Note that the fuel injection holes 15 need not be provided on the main nozzles 11, and, for example, may be provided on the periphery of the main nozzles 11 such as on the wing surface of the main swirlers 14.

The turbine (not illustrated) of the gas turbine engine is driven by the expansion pressure of the combustion gas of the combustion flames emitted from the pilot burner 3 and the main burners 4. As a result, output is produced, and the compressor provided coaxially on the main shaft of the turbine is driven, supplying the compressed air A.

In the present invention, the injection pattern of the liquid fuel F2 injected from the fuel injection holes 15 provided on the main nozzle 11 towards the inner surface 13a of the elongated nozzle 13 is set so as to differ amongst the plurality of main burners 4 (main nozzles 11).

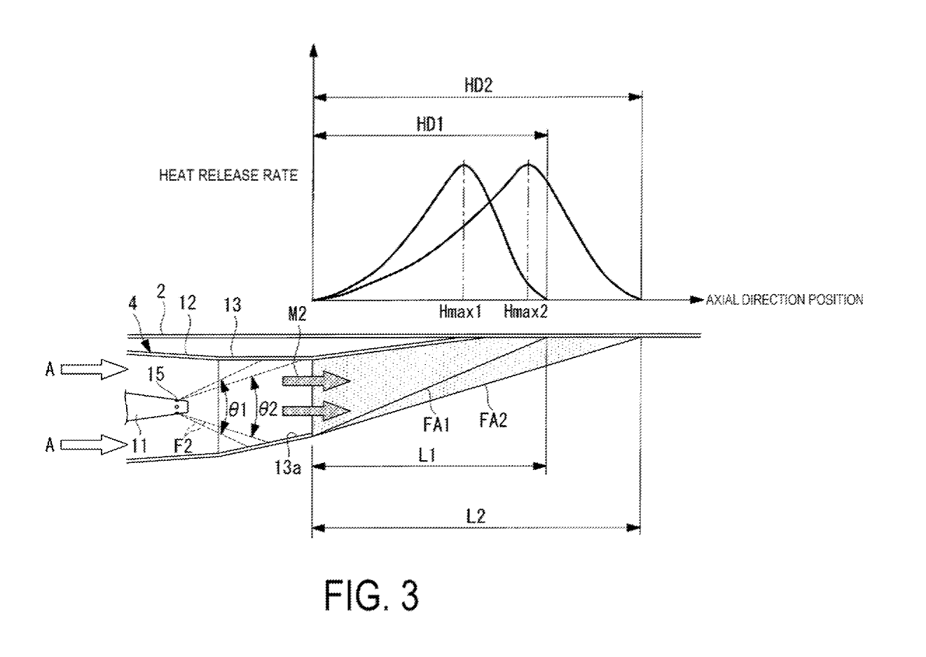

Specifically, an angle of injection of the liquid fuel F2 from the fuel injection holes 15 differs amongst the main burners 4 (main nozzles 11). For example, in FIG. 1, an angle of fuel injection θ2 of the fuel injection holes 15 on the main nozzle 11 on the bottom side is set at a more acute angle than an angle of fuel injection θ1 of the fuel injection holes 15 on the main nozzle 11 on the top side. Consequently, as illustrated in the longitudinal cross-sectional view in the bottom half of FIG. 3, the position at which the liquid fuel F2 hits the inner surface 13a of the elongated nozzle 13 differs between the angle of fuel injection θ1 and θ2. This is, namely, the difference in injection pattern.

As illustrated in FIG. 3, when the angle of fuel injection is θ1, the injected liquid fuel F2 hits the inner surface 13a of the elongated nozzle 13 and atomizes at a position comparatively upstream of the flow of the compressed air A. As a result, the fuel-air mixture M2 is ignited sooner and a length L1 of the combustion flame FA1 is comparatively short. Also, when the angle of fuel injection is θ2, which is more acute than θ1, the injected liquid fuel F2 hits the inner surface 13a of the elongated nozzle 13 at a position comparatively downstream. As a result, ignition is delayed and a length L2 of the combustion flame FA2 is comparatively long.

The graph in the top half of FIG. 3 illustrates the heat distribution of the combustion flames FA1, FA2 inside the combustion casing 2 in the axial direction thereof. As illustrated in the FIG. 3, the axial length of heat release rate distributions HD1 and HD2 and the axial position of points of maximum heat release Hmax1 and Hmax2 differs between the combustion flame FA1, which is formed when the angle of fuel injection of the fuel injection holes 15 is θ1, and combustion flame FA2, which is formed when the angle of fuel injection is θ2.

There are at least two kinds of angles of fuel injection of the fuel injection holes 15, θ1 and θ2. Possible dispositions thereof include dividing eight premixing nozzles 12 (main nozzles 11) into two groups and disposing nozzles of the two groups alternatively, or disposing in symmetry four groups each containing one of each of the nozzles having the angle of fuel injection θ1 and the angle of fuel injection θ2, or disposing the nozzles at random. Also, there may be more than the two kinds of angles of fuel injection, θ1 and θ2.

The gas turbine combustor 1 configured as described above allows for the concentration distribution of the fuel-air mixture M2 (containing the compressed air A and the liquid fuel F2) to be varied amongst the main burners 4 due to the injection pattern of the liquid fuel F2 differing amongst the plurality of main burners 4. Consequently, combustion flames FA1, FA2 emitted from the main burners 4 are varied in length L1, L2 and shape. As a result, the heat release rate distribution HD1, HD2 (the point of maximum heat release Hmax1, Hmax2) of the plurality of combustion flames FA1, FA2 can be prevented from being concentrated at one position in the axial direction of the combustion casing 2, and combustion oscillation of the gas turbine combustor 1 can be effectively suppressed.

As a configuration in which the injection pattern of the liquid fuel F2 differs amongst the plurality of main burners 4, the present embodiment has a simple, high cost-performance configuration in which the angles of injection θ1, 02 of the liquid fuel F2 from the fuel injection holes 15 on the main nozzles 11 differ amongst the plurality of main burners 4. As a result of this configuration, combustion oscillation can be suppressed due to the differing injection patterns of the liquid fuel F2 amongst the plurality of main burners 4.

Moreover, by keeping the shape of the flow paths of the compressed air A the same amongst the plurality of the main burners 4, the shape pressure loss of the air does not change and an unbalance in air distribution does not occur. Consequently, NOx generation caused by the increased average flame speed at the specific main burners 4 that use minimal amounts of air is suppressed, and the amount of NOx generated by the gas turbine combustor 1 as a whole can be reduced.

Note that in the embodiment described above, the main nozzle 11 of each of the main burners 4 has four fuel injection holes 15 disposed in a cross shape, 90° apart from one another, when viewed in a front view, as illustrated in FIG. 2. However, this configuration is not necessary, and there may be a different number of the fuel injection holes 15 and/or the fuel injection holes may be disposed at different positions (intervals).

### Second Embodiment

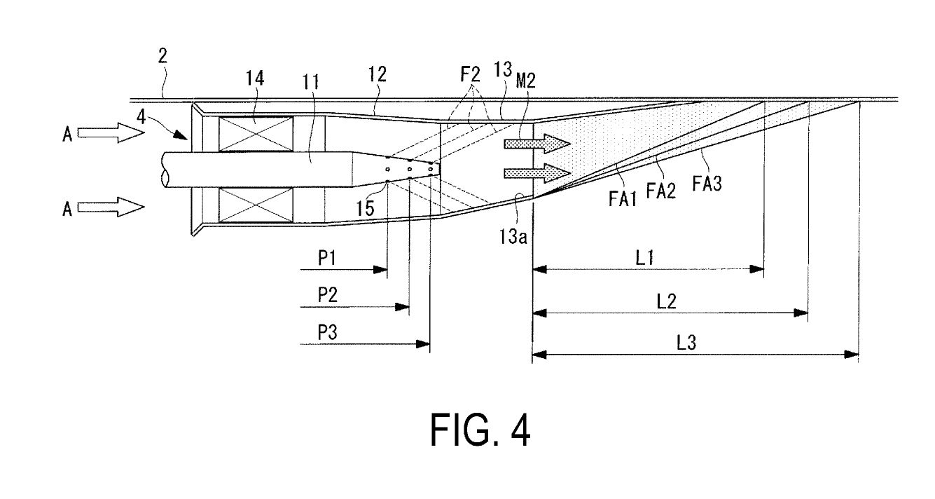

FIG. 4 is a longitudinal cross-sectional view of the main burner 4 and injection flames of the second embodiment of the present invention. As a configuration in which the injection pattern of the liquid fuel F2 injected from the fuel injection holes 15 towards the inner surface 13a of the elongated nozzle 13 differs amongst the plurality of main burners 4, in the present embodiment, the fuel injection holes 15 on the main nozzle 11 of the main burners 4 differ in position in the axial direction.

For example, the fuel injection holes 15 on the main nozzles 11 are disposed at three positions P1, P2, P3 in the axial direction. The closeness to the tip of the main nozzle 11 in ascending order is P1→P2→P3. A plurality of main burners 4 provided with main nozzles 11 having the position of the fuel injection holes 15 differ in the axial direction in such a manner is disposed at random or in groups in the combustion casing 2.

In terms of the positions P1, P2, P3 in the axial direction of the fuel injection holes 15, the liquid fuel F2 injected from a position closer to the tip of the main nozzle 11 hits the inner surface 13a of the elongated nozzle 13 and is atomized at a position further downstream of the flow of the compressed air A. Consequently, the ignition of the fuel-air mixture M2 is delayed and the combustion flames FA1, FA2, FA3 form at lengths L1, L2, L3 respectively.

In such a manner, with an extremely simple, high cost-performance configuration in which the position of the fuel injection holes 15 on the main nozzles 11 in the axial direction are varied, as with that of the first embodiment, the heat release rate distribution (point of maximum heat release) of the plurality of combustion flames FA1, FA2, FA3 can be prevented from being concentrated at one position in the axial direction of the combustion casing 2, and combustion oscillation of the gas turbine combustor 1 can be suppressed.

### Third Embodiment

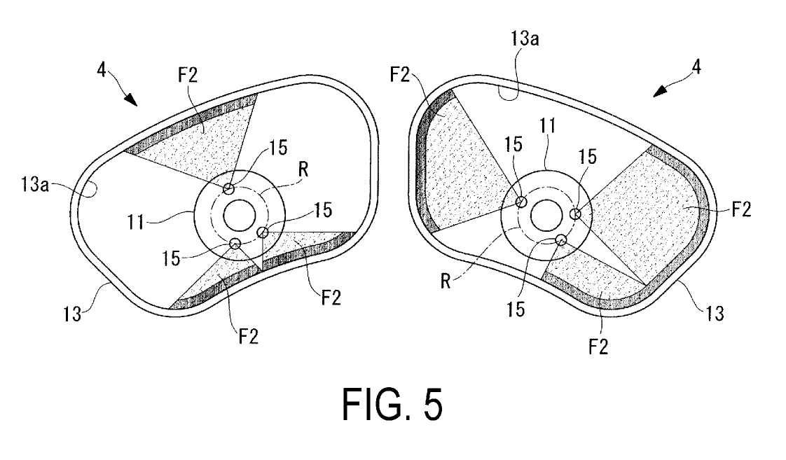

FIG. 5 is a front view of the main burners 4 (main nozzles 11, fuel injection holes 15, and elongated nozzles 13) of the third embodiment of the present invention. As a configuration in which the fuel injection pattern differs amongst the plurality of main burners 4 (main nozzles 11), in the present embodiment, the position in the circumferential direction and pattern of disposition of the fuel injection holes 15 differs amongst the main nozzles 11. Each of the fuel injection holes 15 may have the same diameter, or the diameter may differ.

For example, in the first embodiment, four fuel injection holes 15 are disposed on each of the main nozzles 11 of the main burners 4 in a cross shape, 90° apart from one another, when viewed in a front view, as illustrated in FIG. 2. However, in the third embodiment, three fuel injection holes 15 are formed on each of the main nozzles 11 of adjacent main burners 4. The fuel injection holes 15 are disposed at unequal intervals on the tip of the conical surface of the main nozzles 11 in the circumferential direction R. Consequently, the region at which the liquid fuel F2 injected from the fuel injection holes 15 hits the inner surface 13a of the elongated nozzle 13 differs amongst the main burners 4.

In such a manner, with a simple, low-cost configuration in which the fuel injection holes 15 have differing positions in the circumferential direction and patterns of disposition amongst the main nozzles 11, as with that of the first and second and embodiment, the heat release rate distribution (point of maximum heat release) of the combustion flames emitted from the main burners 4 can be prevented from being concentrated at one position in the axial direction of the combustion casing 2, and combustion oscillation of the gas turbine combustor can be suppressed.

### Fourth Embodiment

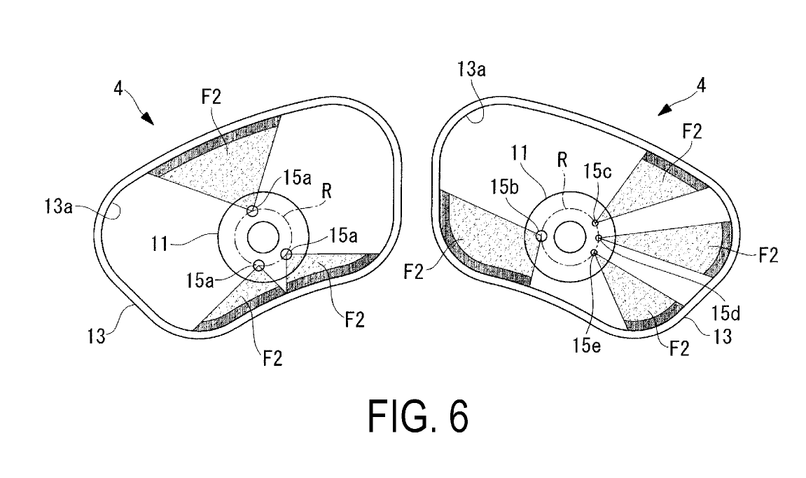

FIG. 6 is a front view of the main burners 4 (main nozzles 11, fuel injection holes 15, and elongated nozzles 13) of the fourth embodiment of the present invention. As a configuration in which the fuel injection pattern differs amongst the plurality of main burners 4 (main nozzles 11), in the present embodiment, the number and diameter of the fuel injection holes 15 differ amongst the main nozzles 11.

For example, in contrast to the main nozzle 11 of a first adjacent main burner 4, on which three fuel injection holes 15a of identical diameter are disposed at unequal intervals, similar to the configuration of the third embodiment (see FIG. 5), the main nozzle 11 of a second adjacent main burner 4 is provided with four fuel injection holes 15b, 15c, 15d, 15e at unequal intervals. Of this group, 15b has a diameter larger than that of 15a. The other three of the group, 15c, 15d, 15e have a diameter smaller than that of 15a. Consequently, the region at which the liquid fuel F2 injected from the fuel injection holes 15a to 15e hits the inner surface 13a of the elongated nozzle 13 differs amongst the main burners 4 in a manner similar to that of the third embodiment. The amount injected also differs.

In such a manner, with a simple, low-cost configuration in which the number and diameter of the fuel injection holes 15 provided on the main nozzles 11 differ from one another, as with that of the first to third embodiments, the heat release rate distribution (point of maximum heat release) of the plurality of combustion flames can be prevented from being concentrated at one position in the axial direction of the combustion casing 2, and combustion oscillation of the gas turbine combustor can be suppressed.

### Fifth Embodiment

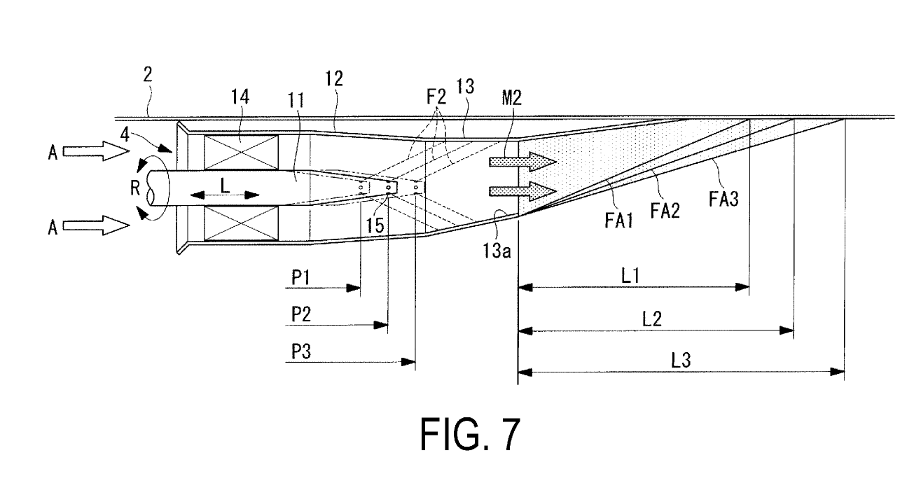

FIG. 7 is a longitudinal cross-sectional view of the main burner 4 and injection flames of the fifth embodiment of the present invention. As a configuration in which the fuel injection pattern differs amongst the plurality of main burners 4 (main nozzles 11), in the present embodiment, the position of the main nozzle 11, with respect to the premixing nozzle 12, is variable in at least one direction of the group consisting of the axial direction L and the circumferential direction R.

Specifically, the main nozzle 11 can be released from being fixed to the premixing nozzle 12 and fixed again to the premixing nozzle 12 after being displaced in the axial direction L and/or the circumferential direction R. Consequently, the position of the fuel injection holes 15 with respect to the premixing nozzle 12 and the elongated nozzle 13 can be varied freely.

For example, the position of the fuel injection holes 15 in the axial direction L can be adjusted from P1 to P2 to P3 in a non-step manner. Consequently, when the fuel injection holes 15 are set at positions P1, P2, P3, the respective combustion flames FA1, FA2, FA3 change to the lengths L1, L2, L3 accordingly, in a manner similar to that of the second embodiment (see FIG. 4).

Also, the position in the circumferential direction R of the fuel injection holes 15 on the main nozzles 11 can be freely set through 360°. Consequently, the region at which the liquid fuel F2 injected from the fuel injection holes 15 hits the inner surface 13a of the elongated nozzle 13 can be set to differ amongst the main burners 4, in a manner similar to that of the third embodiment (see FIG. 5) and the fourth embodiment (see FIG. 6).

In such a manner, the present embodiment has a configuration in which the fuel injection pattern differs amongst the plurality of main burners 4 (main nozzles 11) due to the position of the main nozzles 11 in respect to the premixing nozzles 12 being variable in the axial direction and the circumferential direction.

Consequently, even in the case of the main nozzles 11 themselves having no difference in terms of angle of injection, position, number, diameter, and the like, of the fuel injection holes 15, the position of the fuel injection holes 15 with respect to the inner surface 13a of the elongated nozzle 13 can be freely varied by varying the position of the main nozzle 11 in at least one direction of the group consisting of the axial direction and the circumferential direction.

Consequently, the injection pattern of the liquid fuel F2 injected from the plurality of main burners 4 can be set to a greater variety of configurations, allowing the heat release rate distribution (point of maximum heat release) of the plurality of combustion flames FA1, FA2, FA3, and so on, to be prevented from being concentrated at one position in the axial direction of the combustion casing 2 and combustion oscillation of the gas turbine combustor to be suppressed.

As described above, the gas turbine combustor and gas turbine engine provided with the same of the present invention, wherein the gas turbine engine uses liquid fuel, has a comparatively simple and low cost configuration in which the fuel injection holes 15 provided on the main nozzles 11 are varied, or only the position of the main nozzles 11 in the axial direction and/or the circumferential direction is varied. As a result of this configuration, the concentration distribution of the fuel-air mixture M2 (containing the compressed air A and the liquid fuel F2) is varied amongst the main burners 4 and the length (shape) of the flames emitted from the main burners 4 is varied. Consequently, the heat release position (heat release rate distribution) of the plurality of injection flames can be prevented from being concentrated at one position in the axial direction of the combustion casing 2, and combustion oscillation can be prevented.

Note that the present invention is not limited only to the configurations of the above-described embodiments, and changes and enhancements appropriately made preserving the spirit of the present invention are allowable. Embodiments having such changes and enhancements are included in the scope of claims of the present invention. For example, the embodiments described above and any reference embodiments may be incorporated into one another.

### REFERENCE SIGNS LIST

1 Gas turbine combustor
2 Combustion casing
3 Pilot burner
4 Main burner
5 Pilot nozzle
11 Main nozzle
12 Premixing nozzle
13 Elongated nozzle
13a Inner surface of the elongated nozzle 13
14 Main swirler
15, 15a, 15b, 15c, 15d, 15e Fuel injection holes
A Compressed air
F1, F2 Liquid fuel
M1, M2 Fuel-air mixture
P1, P2, P3 Position of the fuel injection holes in the axial direction
θ1, θ2 Angle of injection of the liquid fuel F2

1. A gas turbine combustor, comprising:
a pilot burner centrally disposed in a combustion casing; and
a plurality of main burners disposed so as to surround a periphery of the pilot burner;
each of the main burners comprising a main nozzle centrally disposed in a cylindrical premixing nozzle, a liquid fuel being injected from fuel injection holes provided on a periphery of the main nozzle towards an inner surface of an elongated nozzle connected to a downstream side of the premixing nozzle; and
an injection pattern of the liquid fuel injected from the fuel injection holes towards the inner surface of the elongated nozzle being set to differ amongst the plurality of main burners.

2. The gas turbine combustor according to claim 1, wherein the differing injection patterns are due to the fuel injection holes having an angle of injection of the liquid fuel differing amongst the plurality of main burners.

3. The gas turbine combustor according to claim 1, wherein the differing injection patterns are due to a position of the fuel injection holes on the main nozzle differing amongst the main burners.

4. The gas turbine combustor according to claim 1, wherein the differing injection patterns are due to the number of the fuel injection holes on the main nozzle differing amongst the main burners.

5. The gas turbine combustor according to claim 1, wherein the differing injection patterns are due to a diameter of the fuel injection holes on the main nozzle differing amongst the main burners.

6. The gas turbine combustor according to claim 2, wherein the differing injection patterns are due to a position of the main nozzle with respect to the premixing nozzle being variable in at least one direction of the group consisting of an axial direction and a circumferential direction.

7. A gas turbine engine, comprising:
a compressor that compresses air;
the gas turbine combustor described in claim 1 that combusts a fuel injected into the air compressed by the compressor; and
a turbine driven by the expansion of a combustion gas exiting from the gas turbine combustor.

8. A gas turbine engine, comprising:
a compressor that compresses air;
the gas turbine combustor described in claim 2 that combusts a fuel injected into the air compressed by the compressor; and
a turbine driven by the expansion of a combustion gas exiting from the gas turbine combustor.

9. A gas turbine engine, comprising:
a compressor that compresses air;
the gas turbine combustor described in claim 3 that combusts a fuel injected into the air compressed by the compressor; and
a turbine driven by the expansion of a combustion gas exiting from the gas turbine combustor.

10. A gas turbine engine, comprising:
a compressor that compresses air;
the gas turbine combustor described in claim 4 that combusts a fuel injected into the air compressed by the compressor; and
a turbine driven by the expansion of a combustion gas exiting from the gas turbine combustor.

11. A gas turbine engine, comprising:
a compressor that compresses air;
the gas turbine combustor described in claim 5 that combusts a fuel injected into the air compressed by the compressor; and
a turbine driven by the expansion of a combustion gas exiting from the gas turbine combustor.

12. A gas turbine engine, comprising:
a compressor that compresses air;
the gas turbine combustor described in claim 6 that combusts a fuel injected into the air compressed by the compressor; and
a turbine driven by the expansion of a combustion gas exiting from the gas turbine combustor.
